(19) United States
(12) Patent Application Publication
(10) Pub. No.: US 2016/0203571 A1
(43) Pub. Date: Jul. 14, 2016

(54) Life Cycle Monitoring and Dispute Resolution Management Systems, Methods and Applications

(71) Applicant: Paul Beshah, St. Louis Park, MN (US)

(72) Inventor: Paul Beshah, St. Louis Park, MN (US)

(21) Appl. No.: 14/993,525

(22) Filed: Jan. 12, 2016

Related U.S. Application Data
(60) Provisional application No. 62/102,190, filed on Jan. 12, 2015.

(51) Int. Cl. G06Q 50/18; G06Q 10/10

(52) U.S. Cl. CPC G06Q 50/182; G06Q 10/10

(57) ABSTRACT

A method of managing dispute resolution on a web-based platform includes identifying a transaction between at least two parties, establishing a secure, cloud-based storage space for receiving information pertaining to the transaction, and storing information pertaining to the transaction in a customizable electronic filing cabinet within the cloud-based storage space. The method also includes screening disputes between the parties to the transaction, tracking electronic communication pertaining to disputes between the parties, providing legal resources for facilitating a resolution of the dispute, and reporting a record of the dispute to users of web-based dispute resolution management system.

### RELATED APPLICATIONS

The present application claims priority to U.S. Provisional Patent Application No. 62/102,190 entitled Life Cycle Monitoring and Dispute Resolution Management Systems, Methods and Applications, filed on Jan. 12, 2015, the content of which is hereby incorporated by reference herein in its entirety.

### TECHNICAL FIELD

The present application relates generally to web-based systems, methods and applications and, more particularly, to web-based systems, methods and applications for storing, tracking, and managing product and service life cycles and documents and managing, directing, and/or documenting dispute resolution processes and steps.

### BACKGROUND

Transactions between one or more parties are a normal part of everyday life. Business and service transactions generate a large quantity of documents, which can be misplaced or lost. These documents can also be difficult to organize, access, and recover. Even documents saved in conventional cloud-based storage can be difficult to locate and retrieve.

The agreements represented by these documents can also lead to disputes between the parties. While these disputes may raise legitimate concerns for an aggrieved party, some disputes may be frivolous and a waste of time and resources for the parties, In legitimate disputes, the parties may have difficulty communicating effectively and efficiently with each other to reach an agreement. When the parties cannot come to an agreement on their own, they may not know what options they have for mediation or other legal services.

### SUMMARY

A method of managing dispute resolution on a web-based platform may include identifying a transaction between at least two parties, establishing a secure, cloud-based storage space for receiving information pertaining to the transaction, and storing information pertaining to the transaction in a customizable electronic filing cabinet within the cloud-based storage space. The method may also include screening disputes between the parties to the transaction, tracking electronic communication pertaining to disputes between the parties, providing legal resources for facilitating a resolution of the dispute, and reporting a record of the dispute to users of the web-based dispute resolution management system.

A web-based product and service life cycle tracking and dispute resolution management system may include an electronic system for receiving information pertaining to a transaction between at least two parties. The electronic system for receiving information may include a secure, cloud-based storage space for storing information received and a customizable electronic filing cabinet within the secure, cloud-based storage space for organizing information received. The electronic system for receiving information may also include a secure, cloud-based storage space for storing information received and a predesigned folder within the customizable electronic filing cabinet for organizing information received such as, for example, warranties. In one or more embodiments, the system may include multiple electronic communication methods to deliver warranty status updates on a regular basis to the two parties or other updates depending on the nature of the transaction or documents being stored and monitored. The web-based life cycle monitoring and dispute resolution management system may also include a dispute monitoring system for tracking a dispute pertaining to the transaction between the at least two parties. In some embodiments, the system may be subscribed to by a consumer and a commercial entity and tracking and/or capturing aspects of the communication between the parties may allow for objective comparison to the agreement and/or any deadlines or dates therein. The life cycle monitoring and dispute monitoring system may also include a filter for screening the dispute and a communication monitoring system for facilitating settlement of the dispute between the at least two parties. The web-based life cycle monitoring and dispute resolution management system may also include a database of legal resources for facilitating resolution of an unsettled dispute and a reporting system for publicly posting a record of the dispute.

### BRIEF DESCRIPTION OF THE DRAWINGS

FIG. 1A is a schematic diagram of a life cycle monitoring and dispute resolution management system.

FIG. 1B is a schematic diagram of users of a life cycle monitoring and dispute resolution management system.

FIG. 2A is a flowchart of a method related to a life cycle monitoring and dispute resolution management system.

FIG. 2B is a flowchart of a method related to a life cycle monitoring and dispute resolution management system.

FIG. 3 is a block diagram of a cloud-based storage space.

FIG. 4 is a block diagram of a communication monitoring system.

FIG. 5 is a block diagram of a satisfactory resolution of a dispute.

FIG. 6 is a block diagram of an unsatisfactory resolution of a dispute.

FIG. 7 is a schematic diagram of a dispute resolution management system user interface.

### DETAILED DESCRIPTION

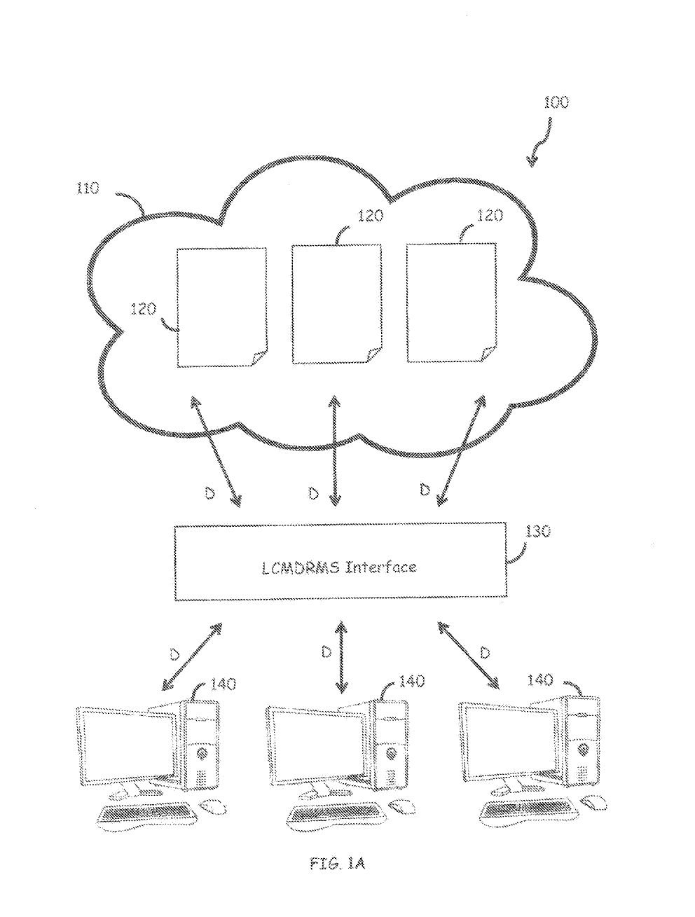

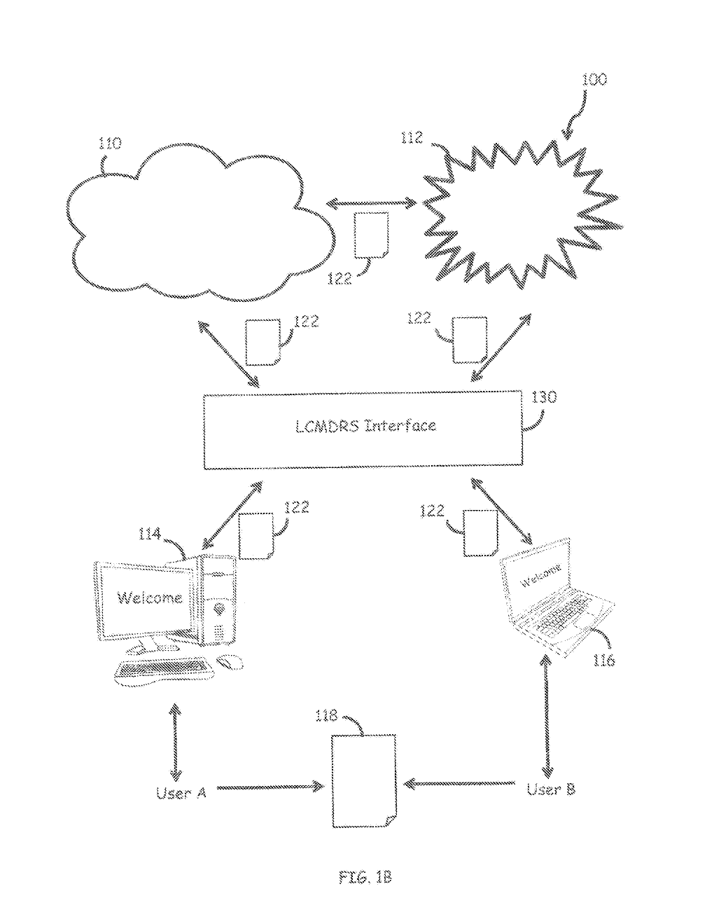

FIG. 1A is a schematic diagram of a life cycle monitoring and dispute resolution management system (LCMDRMS) 100. LCMDRMS 100 may include a cloud-based storage space 110, stored information 120, LCMDRMS interface 130, and electronic devices 140. Electronic devices 140 can be operated by LCMDRMS subscribers, including consumers, and businesses such as car dealerships, appliance stores, realtors, insurance companies, department stores, apartment rental agencies, car repair shops, hotels, hospitals, individual doctors, airlines, cruise lines, lawyers, electricians, plumbers, construction firms, and government agencies. Electronic devices 140 can comprise one or more of desktop computers, laptop computers, computer stations, tablet devices, smartphone devices or any other type of computing device generally able to interface with at least one of a network or the Internet.

Electronic devices 140 can be located at users' homes or places of business, be mobile devices, or be located at one of a plurality of cloud stations (not shown). Cloud stations may allow the user to securely upload documents to cloud-based storage space 110 while remotely accessing LCMDRMS interface 130, which may retain their individual settings, folders, and directories. Cloud stations can be independent storefronts or can be located within an existing business, such as an office print and ship center or retail storefront. Cloud stations can include computers 140 and related devices for users to upload documents. For example, cloud stations can also include auxiliary equipment, such as printers, scanners and fax machines, with a support staff being available to handle questions and fees. Electronic devices 140 may be used to access LCMDRMS interface 130 via a computer network and/or the Internet, where data (D) can be uploaded for storage in cloud-based storage space 110.

Stored information 120 can include transaction records uploaded by a business or consumer, receipts, invoices, service records, warranties, date and/or time-stamped photos or videos of products or services, or any other documents associated with an agreement between two or more parties. Stored information 120 can also include valuable or important documents that the user wants securely stored in case the original copy is misplaced or damaged. Stored information may also include data entered by a clerk, consumer, or other party to a transaction and/or the party's representative or support staff. The data may include details about the transaction such as warranty periods and deadlines, lease dates and terms, and the like.

LCMDRMS interface 130 is associated with cloud-based storage space 110. LCMDRMS interface 130 is easy-to-use. For example, LCMDRMS interface 130 can be streamlined and intuitive, such that subscribers can quickly navigate the system. In some embodiments, the system may be accessible by point of sale (POS) systems so as to automatically upload document relating to a transaction such as user and/or installation manuals, warranties, and the like. Cloud-based storage space 110 can be supported by one or more servers, and may be secure, scalable, and accessible. Using computers 140, users can retrieve, edit, or update stored information 120 in cloud-based storage space 110 via LCMDRMS interface 130 twenty-four hours a day and from virtually any location via any computing device.

FIG. 1B is a schematic diagram of LCMDRMS 100 in the context of an example interaction between user A and user B. This example interaction will be used herein to illustrate uses, interactions with, and features of LCMDRMS 100. LCMDRMS 100 may include a cloud-based storage space 110, life cycle monitoring, life span information communication and dispute resolution management space 112, and LCMDRMS interface 130. User A and user B can enter into an Agreement 118. Agreement 118 can be any type or number of agreements, such as a purchase or service agreement or warranty, for example. User A can access LCMDRMS interface 130 via electronic device 114, while user B can access LCMDRMS interface 130 via electronic device 116. Via LCMDRMS interface 130, user A and user B can upload data 122 pertaining to Agreement 118 to cloud-based storage space 110. Data 122 can comprise documents, receipts, photos, videos, audio recordings (e.g., digital voicemail messages) and/or any other data or information related to Agreement 118 or one of the parties to Agreement 118. Should a dispute arise between user A and user B, user A or user B can access life cycle monitoring and dispute resolution management space 112 via LCMDRMS interface 130. During a dispute between user A and user B, Data 118 pertaining to the dispute can be transferred between cloud-based storage space 110 and life cycle monitoring and dispute resolution management space 112. In this manner, Data 122 pertaining to Agreement 118 and the dispute can be uploaded by user A and user B, securely stored in cloud-based storage space 110, and easily transmitted to dispute resolution management space 112 should a dispute arise. Further, life cycle monitoring system/resolution management space 112 can track communication between user A and user B, and store the communications in cloud-based storage space 110, creating a complete record of the dispute.

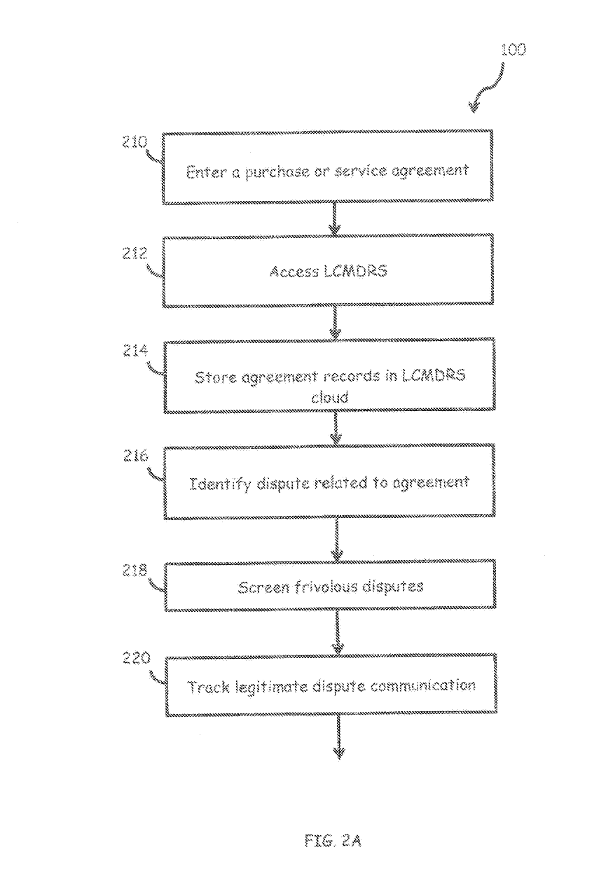

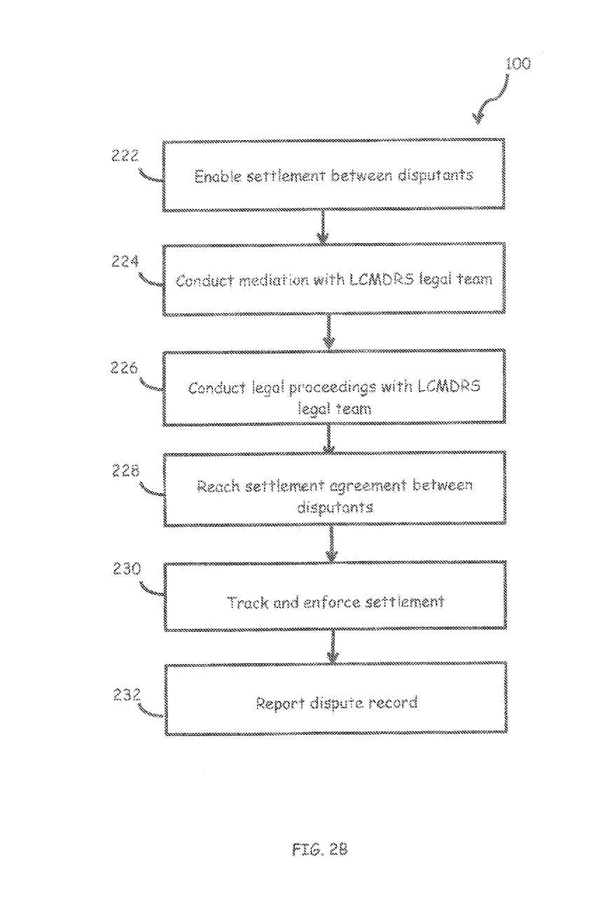

FIG. 2A is a flowchart of a method related to LCMDRMS 100. As previously mentioned, the example embodiment of FIG. 113 with users A and B will be used as an example herein. At 210 user A can enter into a purchase or service agreement with user B. The agreement entered into at 210 can be any agreement between two or more parties, such as point of purchase agreements, warranties, guaranties, insurance documents, and point of service agreements, service guarantees, and other service agreements. In this example, Agreement 118 may include purchase of a used vehicle by user A from user B. At 212 user A and/or user B can access LCMDRMS 100. This access can be on a fee-based subscription model, and consumers and businesses can have different fee structures. For example, if user A is a consumer and user B is a car dealership, user B could pay a higher fee than user A for access to LCMDRMS 100.

Accessing the system may bring users to LCMDRMS interface 130 (shown and described in FIG. 1). With the help of LCMDRMS interface 130, consumers may be able to store agreement records and important documents in a secure cloud-storage space (shown and described in FIG. 1). For example, user A could use electronic device 114 to access LCMDRMS interface 130. After user A has accessed the system, LCMDRMS interface 130 can provide user A with a menu of options, including an option to upload agreement records and important documents related to Agreement 118. At 214, system 100 can automatically generate one or a series of highly secure directories within an electronic filing cabinet, making documents easily recoverable if needed in a potential future dispute. These directories can include insurance directories, such as home, auto, life, and renters; important purchases directories, such as home, auto, stocks, and investments; and maintenance and repair directories, including home, auto, boat, airplane, and cabin. At 214, user A could upload agreement records pertaining to the purchase of a car from user B in user A's personal cloud-based storage space in user A's electronic filing cabinet within that storage space. The agreement records could be filed in a directory entitled “Auto” in a subdirectory labeled with the name of the car purchased. The same agreement might be stored in user B's personal cloud-based storage space in a directory entitled “Customer Purchase Agreements” within a subdirectory labeled with the first letter of user A's last name.

User A and user B can also customize their electronic filing cabinets to include any number of directory and folder arrangements, and at 214, can save documents within folders and directories in chronological order, with each document uploaded for storage being date and time stamped. At 214, system 100 can also generate a unique identification number for each document uploaded to the LCMDRMS cloud. This unique identification number makes the document easily recoverable if it is needed when a dispute arises. The unique identification number can also be linked to a specific issue or complaint should a dispute arise, facilitating availability of the documents for the parties to the dispute. The unique identification number can also be used by LCMDRMS to track important dates related to the documents uploaded. For example, when a warranty or agreement is about to expire, LCMDRMS could send an electronic communication to the user ahead of the expiration at set intervals, such as two months and one month ahead of time, to alert the user. Storing agreement records at 214 allows safe storage of documents that may be crucial in resolving potential disputes related to an agreement between parties.

At 216, user A or user B can identify a dispute related to the agreement entered into at 210. The dispute could include complaints against a business or complaints against a consumer or other issues between two parties. For example, the dispute could arise between a buyer and seller of products, a paying customer and paid service provider, a landlord and tenant, a consumer and rental business, or a home seller and a home buyer. If the car that user A purchased from user B at 210 breaks down one week after the sale, the resolution of that dispute can be facilitated by LCMDRMS. LCMDRMS could also facilitate dispute resolution between two people going through a civil dispute, such as a divorce. At 218, screening frivolous disputes, system ensures the complaints raised by the parties are legitimate, and will not waste the time or money of the parties involved. Before an aggrieved party is able to log an issue on LCMDRMS, that party encounters an agreement to be read and signed to certify the legitimacy of the complaint. For example, if user A logs into LCMDRMS and wants to log an issue with user B for the broken down used car, user A would first encounter instructions warning against the filing of a frivolous dispute, and would then have to sign an agreement certifying user A has read the warning and believes the present dispute is not frivolous.

Screening at 218 can also include audiovisual instructions on lodging only legitimate complaints, which the aggrieved party must view prior to certifying legitimacy and accessing the platform to lodge a complaint. As part of the screening, LCMDRMS 100 can also include a warning prompting the aggrieved party to confirm that he, she, or it has read it prior to certifying the legitimacy of the complaint. Screening can also include keeping a record of frivolous complaints filed by a party and flagging complaints of repeat offenders for review by a LCMDRMS legal team member. For example, if user A's issue with the used car was that user A was careless and ran over a curb in the car, user A would be warned against lodging a complaint against another party when user A was at fault. If user A had a history of lodging frivolous complaints, user A could be prohibited from lodging the complaint until it was reviewed by a LCMDRMS legal team member.

Tracking at 220 can include providing a template or form for the aggrieved party to detail the problem they encountered with a product or service, which is automatically saved in the LCMDRMS cloud. For example, user A can use the documents stored in the LCMDRMS cloud to provide details of the issue in the template, and LCMDRMS can attach the cited documents to the template. In this way, the system provides an interactive, intelligent, and secure method for a consumer, for example, to securely log into the LCMDRMS interface (shown in FIG. 1) and use documents stored at 214 for reference to lodge a complaint against a business.

FIG. 2B is a flowchart of a method related to LCMDRMS 100. As previously mentioned, the example embodiment of FIG. 1B with users A and B will be used as an example herein. The method related to LCMDRMS 100 allows for settlement between disputants 222, allows them to conduct mediation with LCMDRMS legal team 224, and allows them to conduct legal proceedings with LCMDRMS legal team 226. The method may also allow for the parties to reach settlement agreement between disputants 228, track and enforce settlement 230, and report dispute record 232. Settlement between disputants 222 follows track legitimate dispute communication 220 (shown in FIG. 2A).

After a legitimate dispute is lodged, LCMDRMS 100 establishes a collaborative medium for allowing the parties themselves to settle the dispute between them at 222. At 222, LCMDRMS 100 can generate a unique identification code for the legitimate complaint, or issue, to track all communication and documents associated with that issue. Enabling settlement between the disputants can include automatically generating and sending a notification, such as an email, text, phone, or other form of electronic communication, email to the party or parties against whom the aggrieved party or parties is lodging a complaint. The notification generated at 222 can include the details of the dispute with relevant documents attached for reference. The email generated at 222 can also request a prompt reply and sends a copy of the email to the aggrieved party. Enabling settlement between disputants can also involve date and time-stamping each email and automatically saving each email to the LCMDRMS cloud-based storage space using the unique identification code for the issue.

Enabling settlement between the disputants can also include sending a response reminder entailing to the parties when the other party is waiting for a response. Response reminders can be sent to the party that needs to respond on a regular basis, such as every three days, or on schedule set by the aggrieved party. For example, for an urgent dispute, response reminders could be sent on a daily basis. When messages are received, the parties are notified by email to the account associated with their subscription, and users can then log into the secure system to view the message. For example, if user A lodges a complaint against user B and LCMDRMS sends the relevant materials to user B and a receipt to user A, if user B fails to respond within a set period of time, LCMDRMS could automatically send a response reminder to user B. Each reminder can be added to the issue log and communicated to user A. In this way, the parties are provided with a platform to first attempt to solve the dispute themselves and are encouraged to communicate with each other in a timely manner, and each party is kept informed of all relevant information relating to the dispute.

Conducting mediation at 224 can include providing the parties with an alternative means of settling the dispute if they cannot come to an agreement on their own. This mediation allows either one of the parties in the dispute to request mediation. Conducting mediation can include providing a team of legally trained staff to assist in mediation on a fee-based service. Conducting mediation can also include a threshold agreement that when the parties enter into mediation, the agreed upon results are binding and final. For example, if user A and user B cannot reach an agreement through the initial communication provided for at 222, user A could request mediation with a LCMDRMS legal team member to reach a final agreement. Conducting legal proceedings at 226 can include providing assistance for legal proceedings if the parties have failed to come to an agreement on their own or after assistance from the LCMDRMS legal team. This assistance can also include providing legal resources for user A and/or user B, including legal and attorney references. At 226, LCMDRMS 100 can also provide a complete record of the dispute history for use in legal proceedings.

Reaching a settlement agreement at 228 can include recording the dispute as “resolved.” Therefore, if user A and user B reach an agreement on their own or with a LCMDRMS legal team member, the agreement will be binding and final. Tracking and enforcing the settlement at 230 can include sending notifications to the parties when action pertaining to the settlement agreement is required. For example, if user A and user B agree that user A will return the defective used car by a certain date, LCMDRMS 100 can send user A and user B notifications that the agreed upon date is approaching. LCMDRMS 100 can also allow user A and user B to confirm the agreed upon action has been completed, and in this manner LCMDRMS 100 can track when agreed upon actions are not completed. LCMDRMS 100 can then send notifications of the lapsed deadline to the parties and provide user A and/or user B with the legal resources of 226 if the agreement is not adhered to.

Reporting at 232 can include reporting the dispute as “resolved” on LCMDRMS interface 130 (Dashboard), which can be searchable and viewable to a limited extent by the public. Specifically, the public could search for and view the data but not access the other features of the LCMDRMS interface. For example, if the dispute between user A and user B is satisfactorily resolved, that fact would be visible to the public on the LCMDRMS interface. Conversely, if the dispute was unsatisfactorily resolved, that fact is visible to the public as well. Thus, both user A and user B would develop records as a consumer and business, respectively, related to their ability to settle disputes that arise in the course of agreements. In this manner, the parties are encouraged to come to an agreement, whether on their own or with the help of the LCMDRMS legal team before they seek legal action.

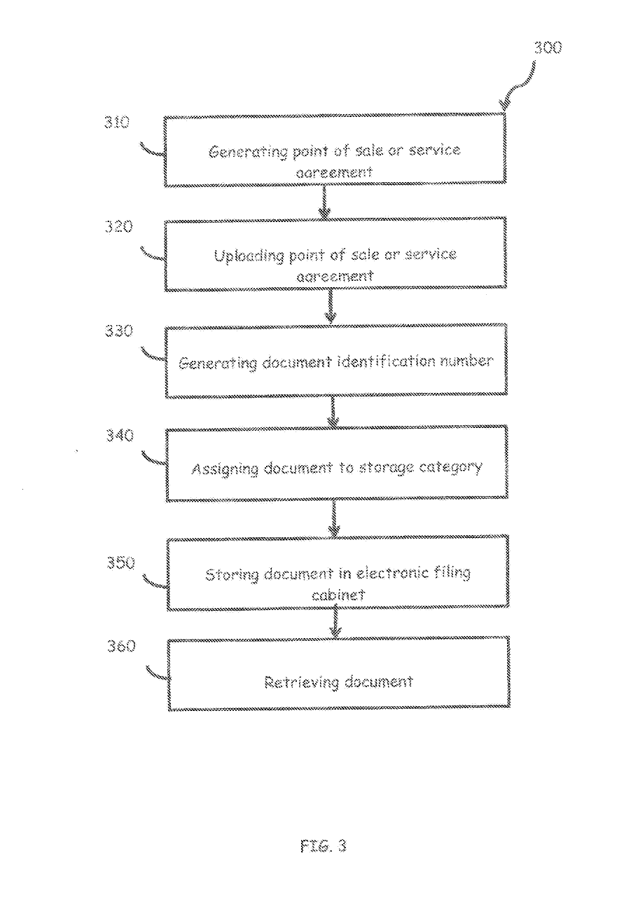

FIG. 3 is a block diagram of a cloud-based storage space 300, which includes 310, generating point of sale or service agreement; 320, uploading point of sale or service agreement; 330, generating document identification number; 340, assigning document to storage category; 350, storing document in electronic filing cabinet; and 360, retrieving document. 310 can include generating any number of agreements between two or more parties, such as service records; warranties and guarantees; date and/or time stamped photos or videos of products, services; date and/or time stamped pictures or videos of rental properties, vehicles, or equipment; or any other documents associated with an agreement between two or more parties. 320 can include LCMDMRS subscribers logging into the LCMDMRS user interface (not shown in FIG. 3) from their home computers or cloud station computers and uploading agreements or documents for storage in an electronic filing cabinet. 330 can include generating a unique identification number for each uploaded document. This unique identification number can be used for easily retrieving the document for reference during a later dispute. 340 can include organizing the documents into directories and folders in an electronic filing cabinet. Assigning document to storage category 340 can include a standard set of pre-set directories including common types of documents a user could want to store in the secure LCMDRMS cloud, including insurance directories, such as home, auto, life, and renters; important purchases directories, such as home, auto, stocks, and investments; and maintenance and repair directories, including home, auto, boat, airplane, and cabin. 340 can also include a mechanism for users to create and organize their own folders and directories. 350 can include the storage of LCMDRMS user documents, photos, videos, and other important information in an organized, secure, cloud-storage space supported by one or more servers. 360 can include a search mechanism for quickly retrieving documents from folders and directories.

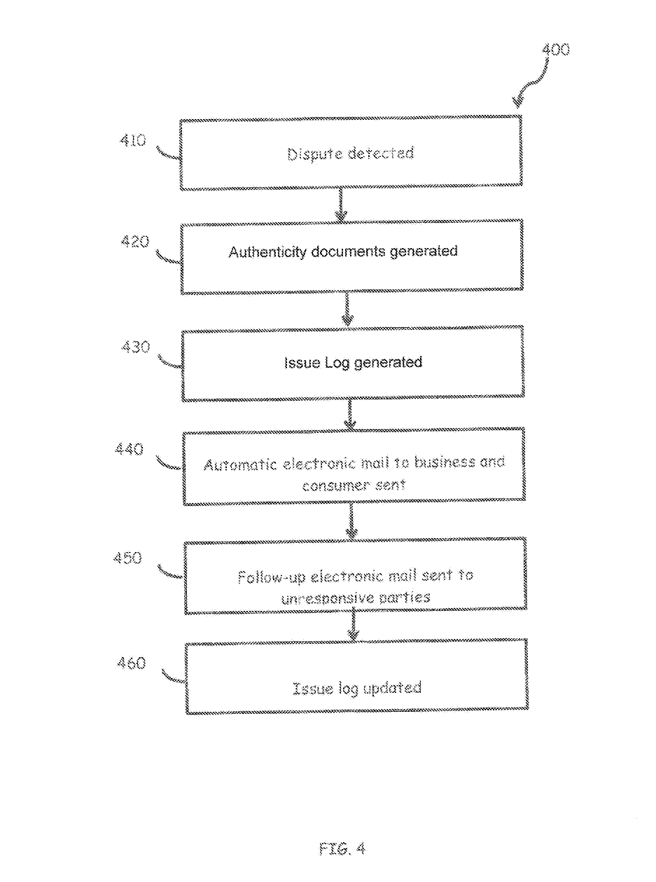

FIG. 4 is a block diagram of communication monitoring system 400, which includes 410, dispute detected; 420, authenticity documents generated; 430, issue log generated; 440, automatic electronic mail to business and consumer sent; 450, follow-up electronic mail sent to unresponsive parties; and 460, issue log updated. Communication monitoring system 400 starts with the detection of a dispute at 410. 410 can include any LCMDRMS consumer or business subscriber lodging a complaint against another party. As described above accompanying FIG. 2A, users are instructed not to lodge frivolous complaints and certify that the complaint they are lodging is not frivolous. These instructions can be written and audiovisual, and can include examples of what LCMDRMS considers a frivolous dispute. 410 can include a means of making the frivolous dispute screening mechanism a mandatory step before lodging a complaint. 420 can include generating authenticity documents including the complainant's signature certifying the dispute is legitimate. 420 includes saving date and time stamped authenticity documents to the issue log. 430 can include creating an issue log with a unique identification number to track all documents and communication related to the dispute. 440 can include automatically generating and sending an email to the party or parties against whom the aggrieved party or parties is lodging a complaint, and generating a receipt for the complainant. The email generated by 440 can include the details of the dispute with relevant documents attached for reference. The email generated at 440 can also request a prompt reply. At 440, LCMDRMS can also date and time stamp each email and automatically save each email to the LCMDRMS cloud-based storage space using the unique identification code for the issue generated at 430. At 450, LCMDRMS can include sending follow-up notifications and reminders to elicit a response from an unresponsive party. 460 can include generating a new issue log entry for each automated email generated by LCMDRMS. Issue log updated 460 can also update the issue log when emails are exchanged between the parties. At 460, LCMDRMS can also include saving each of these communications to the secure cloud-based storage space for future reference, in this way, parties can communicate directly with each other and keep track of the communications at each step of the resolution process.

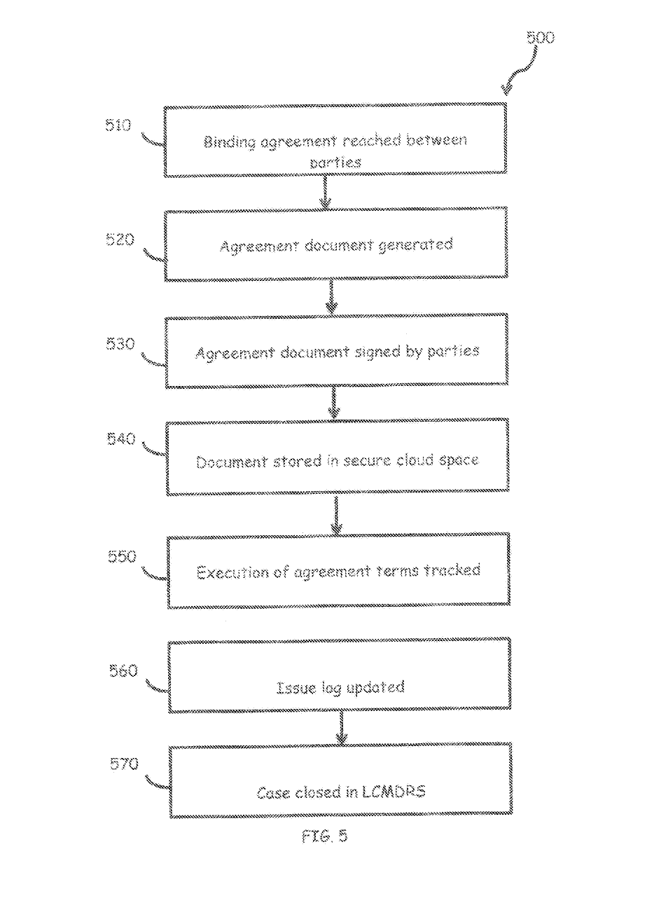

FIG. 5 is a block diagram of satisfactory resolution of a dispute 500, which includes 510, binding agreement reached between parties; 520, agreement document generated; 530, agreement document signed by parties; 540, agreement document stored in secure cloud space; 550, execution of agreement terms tracked; 560, issue log updated; and 570, case closed LCMDRMS. At 510, satisfactory resolution of a dispute 500 can include an agreement reached between the parties to an issue logged in LCMDRMS, either between the parties, or with the help of mediation with the .LCMDRMS legal team. 520 can include generating a document with the terms agreed to by the parties. At 520, satisfactory resolution of a dispute 500 can also include one of the parties drafting and uploading the agreement document. 520 can also include generating a resolution agreement document with the help of the LCMDRMS legal team. 530 can include obtaining signatures from all parties to the agreement via electronic mail, facsimile, or other delivery method. 540 can include storing the signed documents in the secure cloud-based storage space. 550 can include tracking the terms of the agreement and sending notifications when deadlines are approaching. 560 can include logging each completed component of the resolution agreement in the issue log. 570 can include updating the status of the issue to “closed” in LCMDRMS and storing all records associated with the unique identification number for the issue in the LCMDRMS cloud-based storage space.

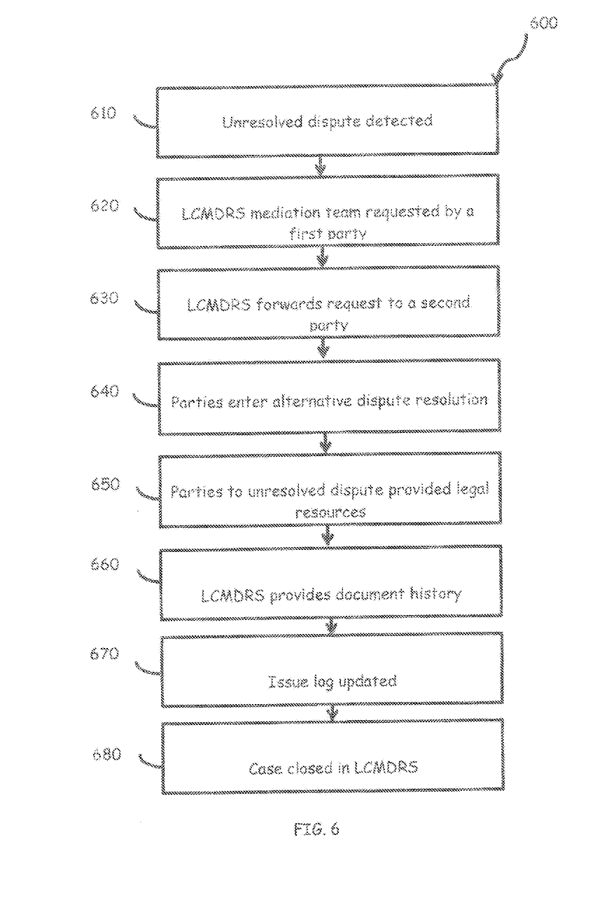

FIG. 6 is a block diagram of unsatisfactory resolution of a dispute 600, which includes 610, unresolved dispute detected; 620, LCMDRMS mediation team requested by a first party; 630, LCMDRMS forwards request to a second party; 640, parties enter alternative dispute resolution; 650, parties to unresolved dispute provided -legal resources; 660, LCMDRMS provides document history; 670, issue log updated; and 680, issue closed in LCMDRMS. 610 can be any dispute that is not satisfactorily settled between the parties. When one party is unsatisfied with the results of the discussions between the parties facilitated by the communication monitoring system (shown in FIG. 4), that party can contact a team of mediators associated with LCMDRMS. An unsatisfactory resolution may occur for many reasons, including a business being unreasonable or uncommunicative, a consumer being unreasonable, or a difference of opinion between the parties. The LCMDRMS mediators can provide alternative dispute resolution services to the parties, or the LCMDRMS mediators can provide resources for the parties to receive alternative dispute resolution services from another source. After a party requests mediation from the LCMDRMS team, at 630, LCMDRMS forwards that request to other parties to the dispute. In forwarding the request to the parties, LCMDRMS can generate the mediation request using the unique case identification number assigned to the issue. LCMDRMS can also compile the entire history of the case, including all stored documents and communication between the parties, and can provide this history to the other parties along with the mediation request. The built-in intelligence of LCMDRMS can then send a mediation request to the other parties and the LCMDRMS legal team. In this manner, all parties to the dispute as well as the LCMDRMS legal team are fully informed about the case history at the outset of the alternative dispute resolution process.

At 640, the parties enter the dispute resolution process, which can track communication between the parties in the same manner facilitated in the communication monitoring system. The LCMDRMS legal team can then assign a neutral, third-party mediator or mediators to the case and begin facilitating the alternative dispute resolution process. The LCMDRMS mediator and the parties can then attempt to resolve the dispute together by negotiating terms that are satisfactory to the parties. At 650, if an agreement cannot be reach through the guided alternative dispute resolution process and a party still remains unsatisfied, the unsatisfied party can be provided with resources for seeking legal action against the other party. This can include information on finding local counsel, information on relevant law, and information on how the court system works. At 660, LCMDRMS can provide the parties with all of the documents and communication associated with the unique identification number assigned to the case. At 670, LCMDRMS can update the issue log for the dispute. In updating the issue log, the dispute can be recorded as resolved or unresolved, and the results can be reported out to the parties and LCMDRMS subscribers. At 680, LCMDRMS closes the case. All documents associated with the case can still be accessed, and any further related disputes can be assigned a new issue identification number. In this manner, LCMDRMS guides the resolution of disputes from inception to completion, keeping all parties fully informed, holding the parties accountable, and generating a comprehensive and complete record of the dispute.

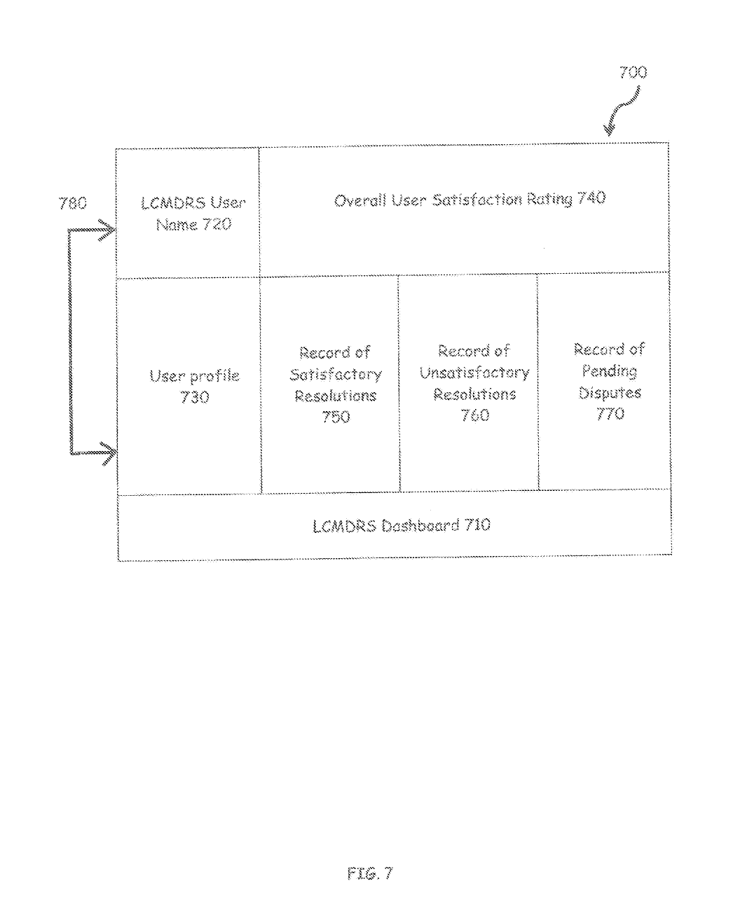

FIG. 7 is a schematic diagram of a user interface 700, which includes LCMDRMS dashboard 710 and badge 780. Badge 780 includes LCMDRMS user name 720, user profile 730, overall user satisfaction rating 740, record of satisfactory resolutions 750, record of unsatisfactory resolutions 760, and record of pending disputes 770. LCMDRMS dashboard 710 can be the main page subscribers see after logging in to LCMDRMS. LCMDRMS dashboard 710 can include access to the individual user's e-filing cabinet (not shown in FIG. 7); audiovisual tutorials about LCMDRMS and how to use the system, including audiovisual instructions on the prohibition of lodging a frivolous complaint; legal resources and contact information; searchable user profiles; and a message center for sending and receiving messages and for communication tracking. User interface 700 also includes badge 780 for quick reporting of information that is accessible to all LCMDRMS subscribers. LCMDRMS user name 720 can be the name of the consumer or business subscriber as entered by the subscriber. User profile 730 can be information the subscriber enters about himself or herself, or about his or her business. Overall user satisfaction rating 740 can be the overall percentage of satisfactorily resolved disputes the user has been a party to. Record of Satisfactory Resolutions 750 can be the specific number of disputes the user has been a party to which have ended in a satisfactory agreement between the parties. Record of unsatisfactory resolution 760 can be the specific number of disputes the user has been a party to which have not ended in a satisfactory agreement between the parties. Record of pending disputes 770 can be the specific number of disputes the user is currently a party to. In this manner, the overall satisfaction among other subscribers of a particular subscriber's rate of resolving disputes is reported out the community, motivating subscribers to settle their disputes. Badge 780 can also be reported out to non-LCMDRMS users searching the Internet for businesses with a good reputation. For example, if a business name is entered into a search engine such as Google or Bing, badge 780 could appear next to the business name to report the business' record of disputes and whether or not the business was able to work through to the satisfaction of its customers,

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of monitoring product and service life cycles and managing dispute resolution on a web-based platform, the method comprising:
identifying a transaction between at least two patties;
establishing a secure, cloud-based storage space for receiving information related to the transaction;
storing information related to the transaction in a customizable electronic filing cabinet within the cloud-based storage space;
storing information related to transactions involving warranties in a predesigned file within a customizable electronic filing cabinet within the cloud-based storage space;
screening a dispute initiated by at least one of the at least two parties to the transaction;
facilitating electronic communication related to the dispute between the at least two parties;
tracking electronic communication related to the dispute between the at least two parties;
providing access to legal resources for facilitating a resolution of the dispute; and
reporting a record of the dispute.

2. The method of monitoring product and service life cycles and managing dispute resolution on a web-based platform of claim 1, wherein identifying a transaction between at least two parties comprises identifying a transaction between a business and a consumer.

3. The method of monitoring product and service life cycles and managing dispute resolution on a web-based platform of claim 1, wherein establishing a secure, cloud-based storage space for receiving information comprises providing access to the cloud-based storage space on a subscription basis.

4. The method of monitoring product and service life cycles and managing dispute resolution on a web-based platform of claim 1, wherein storing. information related to the transaction comprises storing an agreement between the at least parties concerning a product or service.

5. The method of monitoring product and service life cycles and managing dispute resolution on a web-based platform of claim 1, wherein storing information related to the transaction comprises storing information generated at a point of sale or a point of service.

6. The method of monitoring product and service life cycles and managing dispute resolution on a web-based platform of claim 1, wherein storing information related to the transaction comprises storing a plurality of documents.

7. The method of monitoring product and service life cycles and managing dispute resolution on a web-based platform of claim 6, wherein storing information related to the transaction comprises assigning each document in the plurality of documents an individual identification number.

8. The method of monitoring product and service life cycles and managing dispute resolution on a web-based platform of claim 1, wherein establishing a secure, cloud-based storage space comprises providing a plurality of servers.

9. The method of monitoring product and service life cycles and managing dispute resolution on a web-based platform of claim 1, wherein facilitating electronic communication related to the warranty between the at least two parties comprises notifying the parties of the status of the warranty prior to expiration to attempt to avoid a dispute between themselves.

10. The method of monitoring product and service life cycles and managing dispute resolution on a web-based platform of claim 1, wherein establishing a secure, cloud-based storage space comprises providing stations for uploading documents.

11. The method of monitoring product and service life cycles and managing dispute resolution on a web-based platform of claim 1, wherein facilitating electronic communication. related to the dispute between the at least two parties comprises directing the parties to attempt to settle the dispute between themselves before seeking mediation or legal action.

12. The method of monitoring product and service life cycles and managing dispute resolution on a web-based platform of claim 1, wherein reporting the record of the dispute comprises making the record of the dispute available to the public.

13. A web-based product and service life cycle monitoring and dispute resolution management system comprising:
an electronic system for receiving information pertaining to a transaction between at least two parties comprising:
a secure, cloud-based storage space for storing information received; and
a customizable electronic filing cabinet within the secure, cloud-based storage space for organizing information received; and a predesigned file within the customizable electronic filing cabinet for storing information received that involves a warranty; and
a dispute monitoring system for tracking a dispute pertaining to the transaction between the at least two parties comprising:
a filter for screening the dispute; and
a communication monitoring system for facilitating settlement of the dispute between the at least two parties; and
a database of legal resources for facilitating resolution of an unsettled dispute; and
a reporting system for displaying a record of the dispute.

14. The web-based product and service life cycle monitoring and dispute resolution management system of claim 13, wherein the agreement is an agreement made between a consumer and a business at a time of a sale or a service.

15. The web-based product and service life cycle monitoring and dispute resolution management system of claim 13, wherein the at least two parties are subscribers to the dispute resolution management system.

16. The web-based product and service life cycle monitoring and dispute resolution management system of claim 13, wherein the filter includes an agreement prohibiting frivolous disputes.

17. The web-based product and service life cycle monitoring and dispute resolution management system of claim 13, wherein the communication monitoring system includes an issue log.

18. The web-based product and service life cycle monitoring and dispute resolution management system of claim 17, wherein the issue log includes a record of electronic communication between the at least two parties.

19. The web-based product and service life cycle monitoring and dispute resolution management system of claim 18, wherein the issue log includes a case history of all documents related to the dispute.

20. The web-based product and service life cycle monitoring and dispute resolution management system of claim 13, wherein the database of legal resources includes legal resources and attorney references.
